(19) United States
(12) Patent Application Publication
(10) Pub. No.: US 2007/0035905 A1
(43) Pub. Date: Feb. 15, 2007

(54) Power delay device

(76) Inventor: Charles Robert Kessler, Bethesda, OH (US)

Correspondence Address: CHARLES ROBERT KESSLER, 64340 JOHNSON ROAD, BETHESDA, OH, 43719, US

(21) Appl. No.: 11/145,245

(22) Filed: Aug. 15, 2005

(51) Int. Cl. H02H 9/06

(52) U.S. Cl. 361/118

(57) ABSTRACT

The concept of the Power Delay Device began as I was working at my computer. There was a power failure lasting several minutes and when the power tried to come back on, it was erratic. After several attempts the power stayed on. I was concerned about the negative effect of the surges on the electronics in the computer. Even though the computer was using a surge suppressor, I do not trust their effectiveness. I thought that there must be a more thorough device and that is when I built a Power Delay Device. It works beautifully.

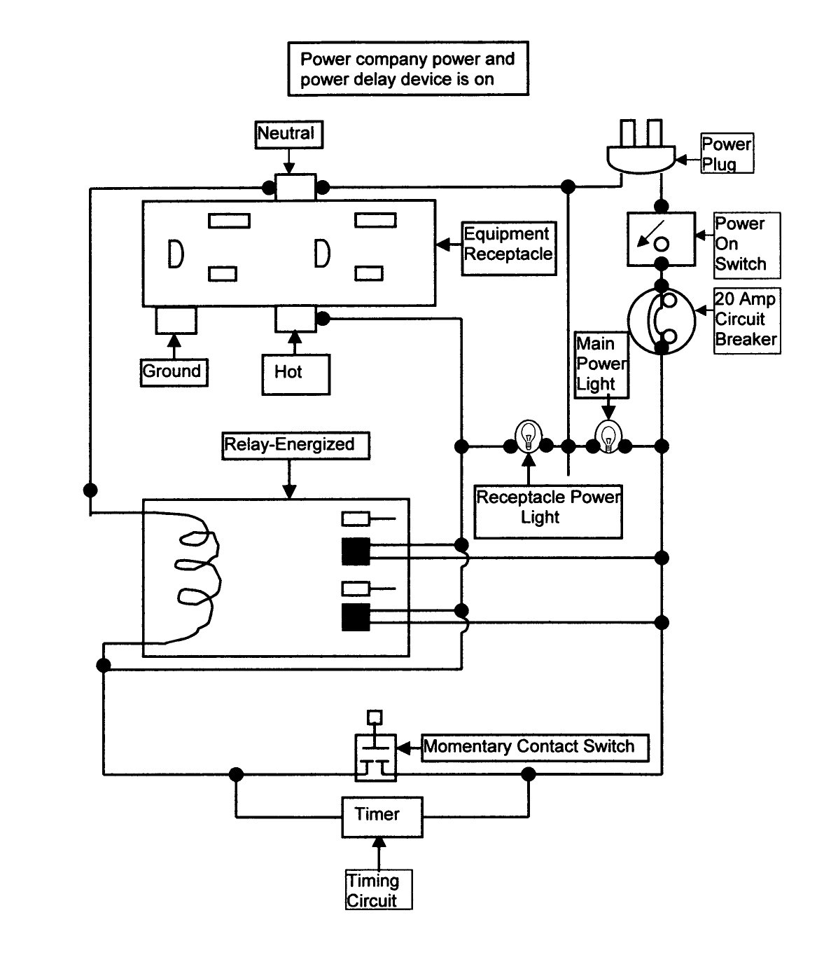

When the power company power is on and the power plug of the Power Delay Device is inserted into the 120v wall receptacle and the On-Off switch of the Power Delay Device is turned on, the Power Delay Device power light is on.

The momentary contact switch in the Power Delay Device is pushed thereby supplying 120v to the relay. The relay in the Power Delay Device stays activated as long as there is 120v at the wall receptacle. The activated relay allows 120v to be applied to the Power Delay Device receptacle.

When there is even a momentary power interruption, such as happens in a storm, the relay in the Power Delay Device is deenergized. Power is shut off to the Power Delay Device receptacle and will not be reapplied until the momentary contact switch is activated. An alternative to the momentary contact switch is the timing circuit, which detects restored power to the wall receptacle and after a pre-set time reapplies power to the Power Delay Device receptacle. Power companies recommend turning off appliances when there is a power outage, to reduce the load when they try to reestablish service.

1. This device can protect refrigerator compressors, which should be left off for a few minutes after a power failure so the refrigerant line pressure can equalize.
This device can also protect air conditioners for the same reason as for refrigerators.
This device can protect electronic equipment from spikes when the power company reapplies power to its lines after a power failure.
This device offers more complete protection than surge suppressors.
This device can protect individual circuits or whole buildings.
